(19) United States
(12) Patent Application Publication
(10) Pub. No.: US 2002/0152293 A1
(43) Pub. Date: Oct. 17, 2002

(54) Dynamic server directory for distributed computing system

(76) Inventors: Terry G. Hahn, Los Altos, CA (US); William Earl, Boulder Creek, CA (US); George Feinberg, Windham, ME (US); Kacper Nowicki, Hayward, CA (US); Waheed Qureshi, Danville, CA (US); Luis Ramos, Glendale, CA (US)

Correspondence Address: PATENT DEPARTMENT, ATTN: BARRY YOUNG, GRAY, CARY, WARE & FREIDENRICH LLP, 1755 EMBARCADERO ROAD, PALO ALTO, CA, 94303, US

(21) Appl. No.: 09/773,059

(22) Filed: Jan. 31, 2001

(51) Int. Cl. G06F 15/16; G06F 7/00; G06F 15/173

(52) U.S. Cl. 709/223; 709/245; 707/104.1; 709/239

(57) ABSTRACT

According to one embodiment, a dynamic server directory (DSD) (300) may include a number of relational tables (302 to 314) having a number of entries. Entries of selected tables (304 to 306) may include information for a server in a distributed computing system. Such information may include a server identification, host machine identification, and server status information. Entries of another table (308) may include host route information. According to one embodiment, dynamic server directory agents (DSDAs), residing on the same machine as a client process, may cache tables of a DSD (300). For a given client request, a client may query a local DSDA to determine which server(s) may service the client request. The local DSDA may then return the route to one or more servers that are available to service the request. Server information in a DSD (300) may be changed in response to changes in server status. Such changes may then be forwarded to DSDAs. Clients may subscribe with the DSDA to receive notification of changes in server and route status. The client may then act in accordance with the change in status.

### TECHNICAL FIELD

The present invention relates generally to distributed computing systems, and more particularly to a method and apparatus for monitoring and controlling access to multiple servers in such systems.

### BACKGROUND OF THE INVENTION

Distributed computing systems may advantageously bring multiple resources to perform a given task. Some distributed computing systems may include a number of servers that can each provide one or more computing functions in the system. In order to determine which server processes a particular request, a directory of servers may be maintained. A drawback to conventional server directory methods can be scalability. Still further, such conventional approaches may require considerable human intervention in response to changing conditions, such as the addition/removal of servers and/or changes in types or numbers of requests. It would therefore be desirable to arrive at a dynamic server directory that can be more scalable or require less human intervention than conventional approaches.

When servicing requests, a distributed computing system may have to select a server, from a number of servers, in order to process a request. The speed at which a server is identified and located can affect the overall performance of the system. It would therefore be desirable to provide a server directory method that can improve the speed at which servers may be identified and selected to process a given request. It would also be desirable for such a server directory method to be capable of scaling to accommodate increased numbers and/or rates of requests to the system.

Another aspect of distributed computing systems can be fault tolerance. In operation, various portions of a distributed computing system may fail. Conventionally error detection and fault tolerance have limited the availability of a system and led to increased costs and undesirable error responses. As but a few examples, the failure of a system host machine or server process may have to be addressed by a system administrator, who may have to manually reconfigure the system to bypass or otherwise address the fault. This can limit the availability of the system. Still further, the addition of a new host machine may also require a reconfiguration of the system to ensure fault tolerant systems include such new host machines. Thus, scalability of fault tolerance in distributed systems can be important features.

In addition, in many arrangements, when an external client accesses a distributed computing system and an error occurs, the system may simply forward an error message to the client. Such a client may have to retry requests and receive multiple errors until the system recovers or the request must be abandoned. It would therefore be desirable to arrive at some way of handling errors that can result in fewer error messages to a client.

In light of the above, it would be desirable to provide a more scalable distributed computing system that is fault tolerant, can improve performance, can be more reliable, handles errors, and may require less human intervention than conventional approaches.

### SUMMARY OF THE INVENTION

According to the disclosed embodiments, a distributed computing system may include a dynamic server directory (DSD) that functions in conjunction with a number of DSD agents. A DSD may include a registry having a number of relational tables that contain information on server processes of the system (server instances) as well as routes to host machines running such server instances. The term relational table may include any representation of the dynamic server information, for example and without limitation, a hierarchical representation of the information such as in a directory server accessed using Lightweight Directory Access Protocol (LDAP), some other tree-like structure, linked lists, or any other data structure that can describe resources used in the distributed system. The term service can be an entire subsystem, which is a collection of service instances. The term service instance can be a collection of server instances. The term server instance can be a particular server.

A DSD may reside on a host machine while DSD agents may reside on a number of other host machines.

DSD agents can hold replicas (copies) of the relational tables of a DSD. In addition, server instances on a host machine can communicate with a local DSD agent to indicate when new server instances are started and/or when the status of existing server instances changes. DSD agents can use a private message protocol to communicate such information to a DSD, which may change its relational tables accordingly. A DSD may then provide updated table information to all of the DSD agents.

According to one aspect of the embodiments, gateway server instances may receive external client request for the system. The gateway server instance can query a local DSD agent to determine the identification of one or more server instances that are capable of handling the client request.

According to another aspect of the embodiments, a communication network may interconnect the various host machines of a system. In response to external client requests, a gateway server instance can query a local DSD agent to determine a route to one or more host machines having a server instance that is capable of handling the client request.

According to another aspect of the embodiments, a DSD relational table may relate a system service instance to a server instance.

According to another aspect of the embodiments, a DSD relational table may relate a server instance to a corresponding host machine location and a server identity on that host machine.

According to another aspect of the embodiments, a system may store metadata on partitions. A DSD relational table may relate a metadata partition to a metadata service (MDS) instance.

According to another aspect of the embodiments, a system may store files on partitions. A DSD relational table may relate a file partition to a bitfile storage service (BSS) instance.

According to another aspect of the embodiments, server instances may periodically contact local DSD agents to provide a status indication. Such periodic contacts (heartbeats) can indicate a time period in which a subsequent contact is expected. If a subsequent contact is not made, a DSD agent may, for example but without limitation, mark the entry as invalid to notify the DSD that the server instance is not available.

According to another aspect of the embodiments, a DSD may receive periodic messages from each DSD agent via each of the routes from the DSD agent's host machine to the DSD's host machine. A DSD can then determine if a route to a particular host machine fails. This information may be forwarded to DSD agents. In response to such changes in route status, a client application may undertake one or more predetermined actions, including re-routing a request via a different route indicated in a local DSD agent cache.

According to another aspect of the embodiments, a DSD may send periodic messages to the DSD agents via each of the variable routes to allow each DSD agent to verify that it can receive messages from each of its network connections. The DSD can send these messages using, for example but without limitation, a multicast protocol. If a DSD agent detects a route failure as a result of messages not appearing on a timely basis, the DSD agent may mark that route as failed and forward a notice to the DSD about the failed route.

### BRIEF DESCRIPTION OF THE DRAWINGS

FIG. 1 is a block diagram of a storage system according to one embodiment

FIGS. 2A to 2G are examples of relational tables that may be included in an embodiment.

FIG. 3 is a block diagram of a dynamic server directory (DSD) according to an embodiment.

FIGS. 4A and 4B are block diagrams showing the addition of an entry to a DSD according to an embodiment.

FIG. 4C shows redirection of a request upon route failure according to an embodiment.

FIGS. 5A and 5E show selected DSD functions according to an embodiment.

FIGS. 6A to 6C show a service master arrangement according to one embodiment.

FIG. 7 is a block diagram illustrating DSD scalability according to one embodiment.

### DETAILED DESCRIPTION OF THE EMBODIMENTS

Various embodiments of the present invention will now be described in conjunction with a number of diagrams. The various embodiments include a dynamic server directory (referred herein as a “DSD”) that may include a number of relational tables that include server information and host machine route information for a distributed computing system. One or more host machines may include a DSD, while the remaining host machines may include a DSD agent. DSD agents may cache DSD relational table information, and receive periodic changes in table information from the DSD.

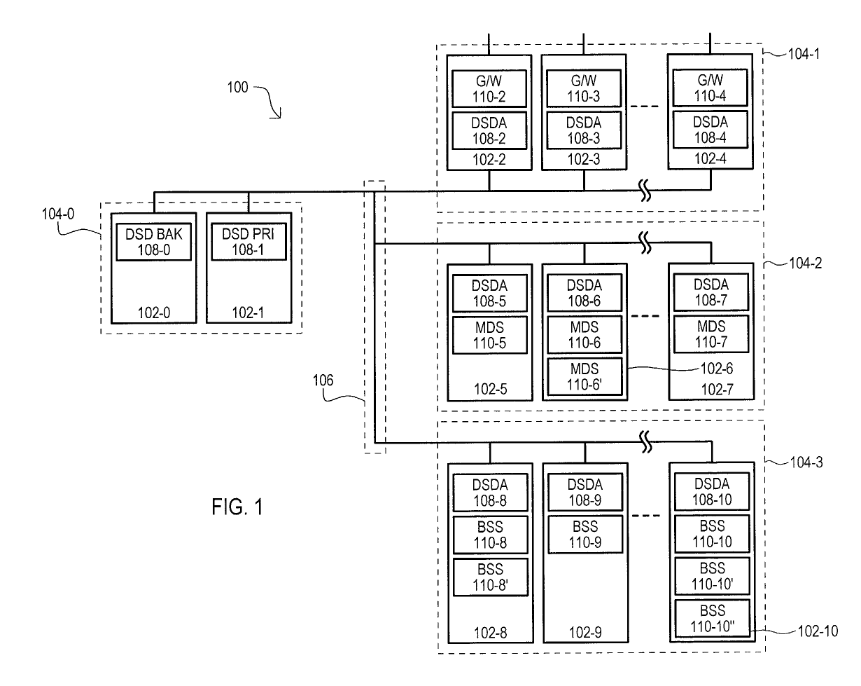

Referring now to FIG. 1, a block diagram is set forth showing a distributed computing system according to one embodiment. The distributed computing system is designated by the general reference character 100, and may include a number of host machines 102-0 to 102 10. A host machine (102-0 to 102-10) may include a computing resource that may run one or more instances of a given server process. It is understood that host machines (102-0 to 10210) do not necessarily include the same hardware and may run different server processes. For example, some host machines may include hardware that can be optimized for one particular server process, while others may include different hardware that may be optimized for another server process. A server process and a service process can refer to a process or an instance of a process. The term process should not be construed as to limit the invention.

In the particular arrangement of FIG. 1, host machines may be conceptualized as being divided into a Dynamic Server Directory (DSD) service and three other services. A service may include host machines that run server processes providing a particular function or range of functions. Thus, host machines 102-0 and 102-1 are included in a Dynamic Server Directory (DSD) 104-0. Similarly, host machines (102-2 to 102-4) are included in a gateway service (GS) 104-1, host machines (102-5 to 102-7) are included in a metadata service (MDS) 104-2, and host machines (102-8 to 102-10) are included in a bitfile storage service (BSS) 104-3. The host machines (102-0 to 102-10) may communicate with one another by way of a communication network 106, for example and without limitation, a redundant non-blocking switched network.

Of course, the particular numbers of host machines in the various services (104-0 to 104-3) should not be construed as limiting to the invention. A service (104-0 to 104-3) may include a larger or smaller number of host machines.

Host machines of a DSD service 104-0 may include a DSD as described above. In the particular example of FIG. 1, host machine 102-0 may include a back-up DSD 108-0, while host machine 102-1 may include a primary DSD 108-1. The remaining host machines (102-2 to 102-10) may include DSD agents 108-2 to 108-10.

As noted, the various host machines may include server processes that can enable a system 100 to distribute predetermined functions. In the example of FIG. 1, host machines (102-2 to 102-4) of a gateway service (GS) 104-1 may include gateway server processes 110-2 to 110-4. Gateway server processes (110-2 to 110-4) may include instances of the same server process. Further, while one gateway server process is shown in each host machine 102-2 to 102-4, more than one gateway server process may reside on the same host machine.

In a similar fashion, host machines (102-5 to 102-7) of a metadata service (MDS) 104-2 may include metadata server processes 110-5 to 110-7. Such processes 110-5 to 110-7 may be instances of the same metadata process, or one or more metadata server processes may be different from the others. Further, as illustrated by host machines 102-6 and 102-7, multiple metadata server processes may reside on the same host machine.

Like a gateway service 104-1, host machines (102-8 to 102-10) of a bitfile storage service (BSS) 104-3 may include storage server processes 110-8 to 110-10″. Such processes (110-8 to 110-10″) may be the same or different, and multiple storage server processes may reside on the same host machine.

Server processes (110-2 to 110-10″) can communicate with a DSD agent of their corresponding host machine (102-2 to 102-10). For example, server process 110-2 can communicate with DSD agent 108-2, while server processes 110-10, 110-10′ and 110-10″ can communicate with DSD agent 108-10.

Having described the general arrangement of a DSD and corresponding DSD agents, particular examples of DSD/DSD agent relational tables will now be described.

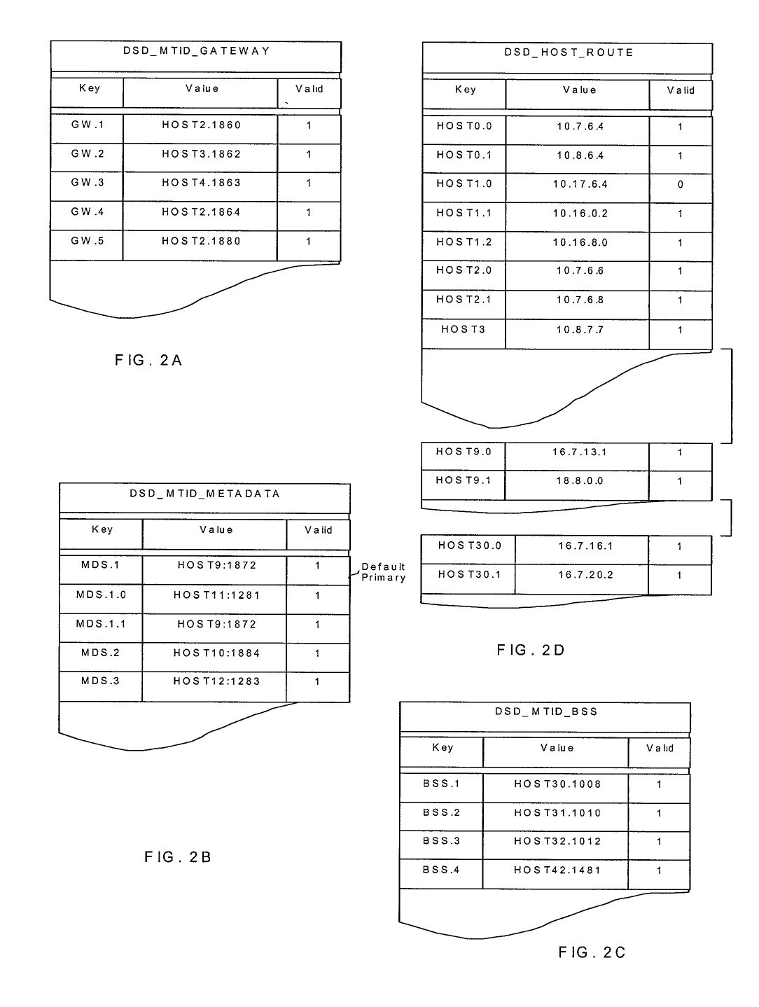

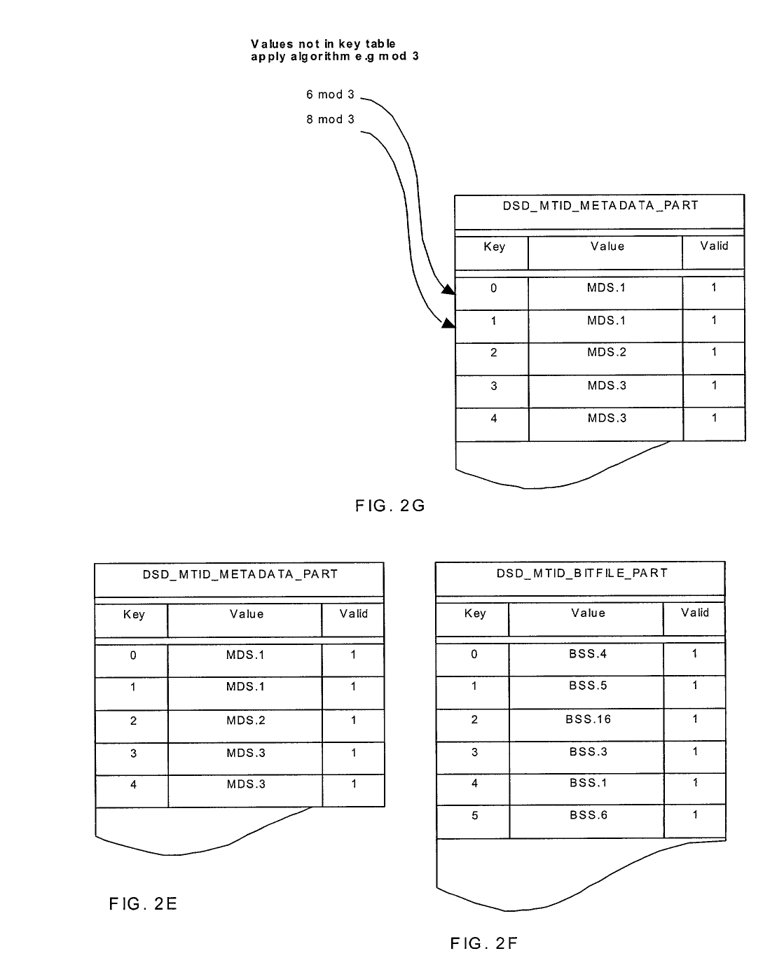

Referring now to FIGS. 2A to 2F, various relational tables are shown that may be included in a DSD (and cached in a DSD agent) according to one embodiment. It is noted that the relational tables described below can include a common form. Namely, each table may include three fields, a “key” field, a “value” field, and a “valid” field. Of course, such tables are representative of a particular embodiment, and the present invention should not be construed as being limited thereto.

FIG. 2A shows an example of a relational table for the various processes of a gateway service, such as that shown as 104-1 in FIG. 1. The gateway process table is labeled DSD_MTID_GATEWAY, and may have a key field that identifies a particular gateway service instance. A gateway service instance can be the same as a gateway server instance that identifies the server process. A value field may include a server route corresponding to each server process. A server route is a host identifier (host name) and a server identity on the assigned host. The server identity may include, for example and without limitation:

a network port number

additional information such as, for example and without limitation, an object key for the server (This additional information depends on the protocol used to access the server, for example and without limitation the Internet InterObject Request Broker (ORB) Protocol (IIOP) of the Common Object Request Broker Architecture (CORBA) specification.)

In the particular example of FIG. 2A, a server route may include an assigned host name and a network port. A valid field may include a Boolean value that may be checked to determine if the entry is valid or invalid. An invalid notation (in this case a “0”) can indicate that the corresponding server process is not available, for example. In the example of FIG. 2A, a service instance GW.1 and the server instance are the same because the service instance, which is a collection of server instances, only has one server instance. FIG. 2B shows an example of a relational table for the various processes of a metadata service, such as that shown as 104-2 in FIG. 1. The metadata process table is labeled DSD_MTID_METADATA, and may have a key field that identifies a particular service instance of a metadata service (MDS) and particular server instance of a MDS service instance. A service instance includes one or more server instances that can identify a process as primary or backup process. A value field, like that of FIG. 2A, may include a server route corresponding to each server instance. A valid field may also have the same general function as the table of FIG. 2A. In the example of FIG. 2B, the default service instance identifies the primary process. A server instance MDS.1.1 has therefore been selected as a primary process while server instance MDS.1.0 can be a backup process for service instance MDS.1. FIG. 2C is similar to FIGS. 2A and 2B. FIG. 2C shows an example of a relational table for the various processes of a bitfile storage service (BSS), such as that shown as 104-3 in FIG. 1. The storage server process table is labeled DSD_MTID_BSS. A key field in FIG. 2C can identify a particular storage service instance. A storage service instance can be the same as a storage server instance that identifies the server process. A value field and valid field may be similar to FIGS. 2A and 2B. In the example of FIG. 2C, a service instance BSS.4 and the server instance are the same because the service instance, which is a collection of server instances, only has one server instance. In this way, a DSD and DSD agents may store information on the various types of server processes within a distributed computing system. Such information can enable a particular server process to be selected in order to service a client request.

In addition to server capability, server status, and server route information, a DSD and DSD agents may also store host route information to enable a server process to be accessed. In one particular approach, such information may be included in a host route table.

FIG. 2D shows an example of a relational table for the various routes to host machines of distributed computing system. The host route table is labeled DSD_HOST_ROUTE, and may have a key field that identifies a particular host machine name. A value field may include a network route to a host machine. In FIG. 2D, such a route is represented by a four-octet network address. As in the case of the tables shown in FIGS. 2A to 2C, a valid field may include a Boolean value that may be checked to determine if the route is valid or invalid. An invalid notation (in this case a “0”) can indicate that the route to a host machine is not available.

The notation of FIG. 2D can also indicate alternate routes to host machines. For example, two routes are available to host machine HOST0: 10.7.6.4 and 10.8.6.4. Any number of methods can be used to select a route. In this example, route 10.7.6.4 is selected as the route to HOST0 based on HOST0 having the lowest number (0.0) of the two routes to host machine HOST0. However, should route 10.7.6.4 fail, alternate route 10.8.6.4 can be selected. In the example of FIG. 2D, route 10.17.6.4 to HOST1 is invalid (as indicated by the value 0 for the valid field), and alternate route 10.16.0.2 has been selected as the current route to HOST1.

In this way, a DSD and DSD agents may store route information to various system host machines, including alternate routes and the status of each route. Such information can enable a particular route to a host machine to be selected in order to process an external client request.

Gateway, metadata and storage server process tables may be used in conjunction with a host route table to access a particular server process for fulfilling a request. Such an operation may be understood by example. A client may make a metadata service query to a local DSD agent. A local DSD agent may access a metadata process table (DSD_MTID_METADATA) to determine the server route of an appropriate metadata server instance. In this example, it will be assumed that service instance MDS.1 is selected. From the metadata process table, service instance MDS.1 is shown to reside on HOST9 (at port 1872). A DSD agent may then use the HOST9 identifier and access a host route table (DSD_HOST_ROUTE) to determine a route to HOST9. The host route table can identify HOST9 as HOST9.0 and HOST9.1. As shown in FIG. 2D, the current route to HOST9 can be identified as HOST9.0 with IP address 16.7.13.1. The DSD agent may then return a value 16.7.13.1 to a client process, which can then access HOST9 and allow metadata server process MDS.1 to service the request.

It is understood that while particular value fields are illustrated in FIGS. 2A to 2D, such fields may include additional information.

Additional relational tables that may be included in a DSD or DSD agent are shown in FIGS. 2E and 2F. Such tables can be used to provide direct or indirect mapping between partitions identified by a numeric or string key and server names. Such tables can provide access to particular storage locations for metadata or files. Files can be any media such as file data, set of blocks of data, a block of data, data abstraction, etc. The term files should not be construed as to limit the invention to any particular semantic. In a direct mapping arrangement, each file stored in a file system may have a particular identifier (e.g., a numeric or string key). Such a file identifier may include information on the particular storage location for a given file, or the location of metadata corresponding to the given file. In the examples if FIGS. 2E and 2F, it will be assumed that such information is a metadata storage partition number and/or a file storage partition number. In an indirect mapping arrangement such as that shown in FIG. 2G, a partition number extracted from the numeric or string key that is not in the partition table could be processed first using some algorithm for example, but without limitation, modulus 3. That value can then be used to look up in the partition table.

FIG. 2E shows an example of a relational table for metadata partition numbers. The metadata partition number table is labeled DSD_MTID_METADATA_PART. A key field in FIG. 2E can identify a metadata partition number. A value field can identify a particular metadata service instance that may access the metadata partition. A valid field may indicate whether a metadata partition-service instance correspondence is valid or not. In the example of FIG. 2E, metadata partition 0 can be accessed by metadata service instance MDS.1. Further, metadata service instance MDS.1 may also access metadata partition 1.

FIG. 2F shows an example of a relational table for file partition numbers. The file partition number table is labeled DSD_MTID_BITFILE_PART. A key field in FIG. 2F can identify a file partition number. A value field can identify a particular storage server instance that may access the file partition. A valid field may indicate whether a file partition-server instance correspondence is valid or not. In the example of FIG. 2F, file partition 0 can be accessed by storage server instance BSS.4.

FIG. 2G shows an example of relational tables for indirect mapping. The metadata partition number table is labeled DSD_MTID_METATDATA_PART. A key field in FIG. 2G can identify a metadata partition number. If the metadata partition number is not in the DSD_MTID_METADATA_PART table, mod 3 or some other algorithm may be applied to the value to ascertain the partition number. For example value 6 mod 3, maps to metadata partition 0 (MDS.1), and value 8 mod 3, maps to metadata partition 2 (MDS.2). This same indirect mapping can be used for file partitions found in the DSD_MTID_BITFILE_PART table.

Metadata and file partition tables may be used in conjunction with a host route table to access a particular server process for fulfilling a request. Such an operation may be understood by example. A gateway server process may receive a request to access a file. Such a gateway server process may extract a file partition number and pass the information on to a local DSD agent. The local DSD agent may access a file partition table (DSD_BITFILE_METADATA) to determine a storage server instance corresponding to the file partition. A storage server process table (DSD_MTID_BSS) can then be accessed to determine the server route of an appropriate storage server process. A DSD agent may then use a host identifier, which is included in the server route, and access a host route table (DSD_HOST_ROUTE) to determine a route to the host of the storage server process.

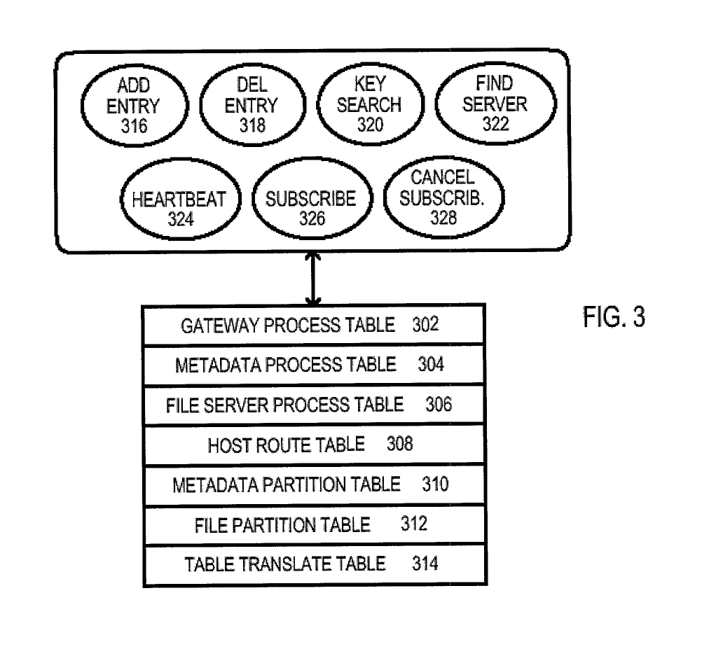

Referring now to FIG. 3, a DSD agent according to one embodiment is shown in a block diagram and designated the general reference character 300. A DSD agent 300 may include various relational tables described above, including tables for gateway processes 302, metadata processes 304, storage server processes 306, host routes 308, metadata partitions 310, and file partitions 312. The particular example of FIG. 3 further includes a translation table 314. A translation table 314 can be used to translate symbolic table names into actual table identifiers.

In the embodiment of FIG. 3, a DSD agent 300 may also include various interfaces that can access the relational tables (302 to 314). While the present invention may include various interfaces that provide particular functions, seven specific interfaces are shown. The interfaces shown include an add entry interface 316, a delete entry interface 318, a key search interface 320, a find server interface 322, a “heartbeat” interface 324, a subscribe interface 326, and a cancel subscription interface 328.

Various interfaces of a DSD agent will now be described in more detail.

Add/Delete Entry.

An add entry interface can receive entry values (e.g., a key, a value, and valid indication) and add the entry to an existing table. In one particular arrangement, an add entry interface function can be called to change one or more fields of a table entry, by supplying a new entry with the changed field. Similarly, a delete entry interface can receive a key value, and in response thereto, delete an entry from an existing table.

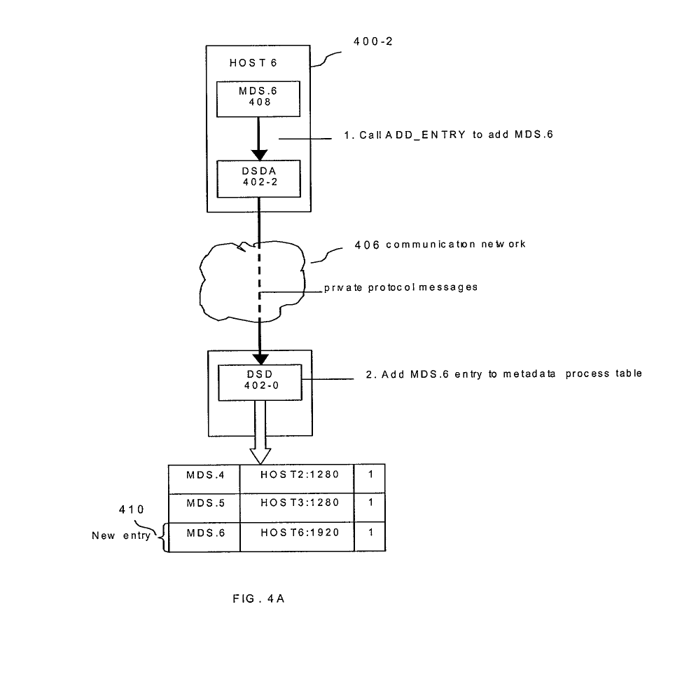

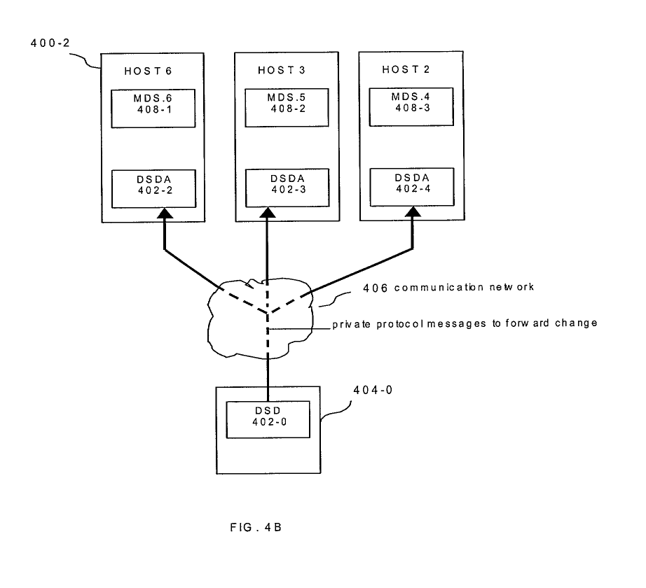

According to one embodiment, add/delete entry interfaces (316 and 318) may be invoked by MDS servers as they become available and unavailable for service. However, requests to change table entries are sent from DSD agents to the DSD, which forwards the change to all DSD agents. An add entry operation is described in FIGS. 4A and 4B.

FIG. 4A shows a host machine 400-2 that includes a local DSD agent 402-2. Host machine 400-2 can be connected to another host machine 404-0 by a communication network 406. A DSD 402-0 may reside on host machine 404-0.

In the example of FIGS. 4A and 4B, a new server process MDS.6 408 may be initialized on host machine 404-0. Upon initialization, server process MDS.6 408 can, by invoking an add entry interface function of the local DSD agent 402-2, request to be added to a server process table. Such a request may include information needed for a table entry (e.g., a key “MDS.6”, a value “HOST6:1920”, and a valid indication “1”). New table information may then be included when a DSD agent 402-2 forwards the add entry request to DSD 402-0 using private protocol messages. DSD 402-0 may then add the new entry to a server process table, part of which is shown as 410.

With a server table now updated, a DSD 402-0 may forward new table information to all DSD agents. Such an operation is shown FIG. 4B. Three particular DSD agents are shown as 402-2,402-, 402-4 in FIG. 4B. In one particular arrangement, a DSD 402-0 may use private protocol messages to forward the new entry to DSD agents (402-2, 402-3, and 402-4).

Of course, while FIGS. 4A and 4B show an add entry operation, as noted above, the same sort of operation may be used to indicate changes in a particular entry and/or to delete a particular entry. Further, while FIGS. 4A and 4B are related to a new server process, host route tables may also be updated in the same general fashion.

In this way, changes in server processes (including additions and deletions of server processes) may first be initiated in a DSD relational table, and then forwarded to cached relational tables in DSD agents. Such an arrangement can prevent cached server process data from becoming outdated (“stale”).

Key Search and Find Server.

A key search interface function can be called to search a relational table based on a key prefix value. Entries having a matching key prefix can then be returned. In one particular arrangement, keys may be string variables, and a key prefix can be matched against a predetermined number of leading characters in the key string.

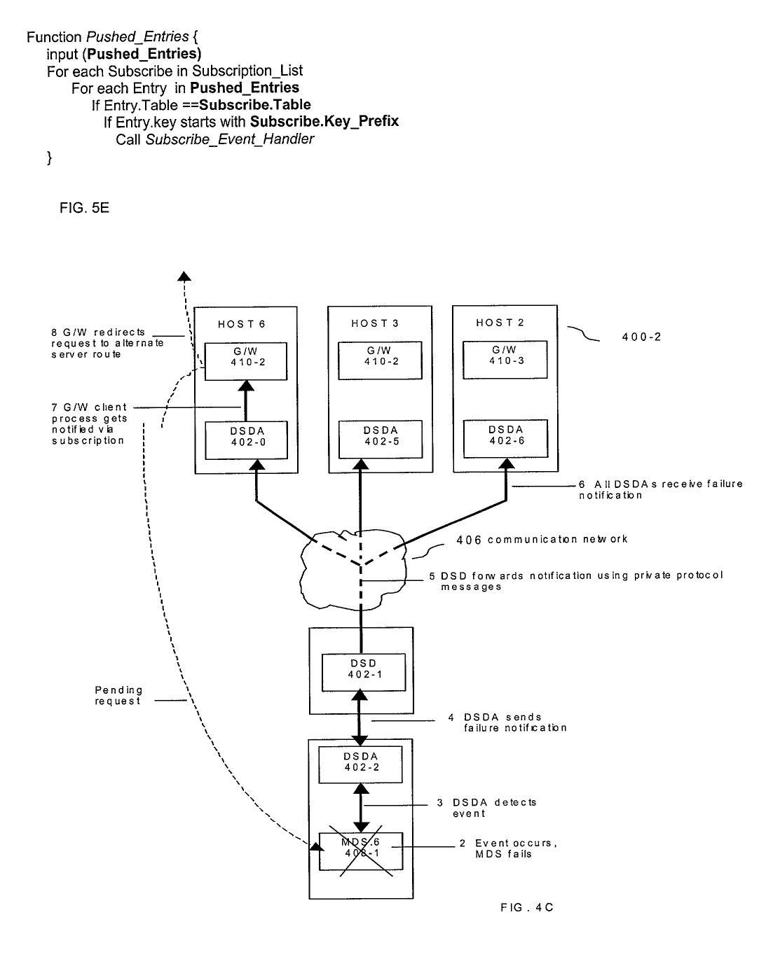

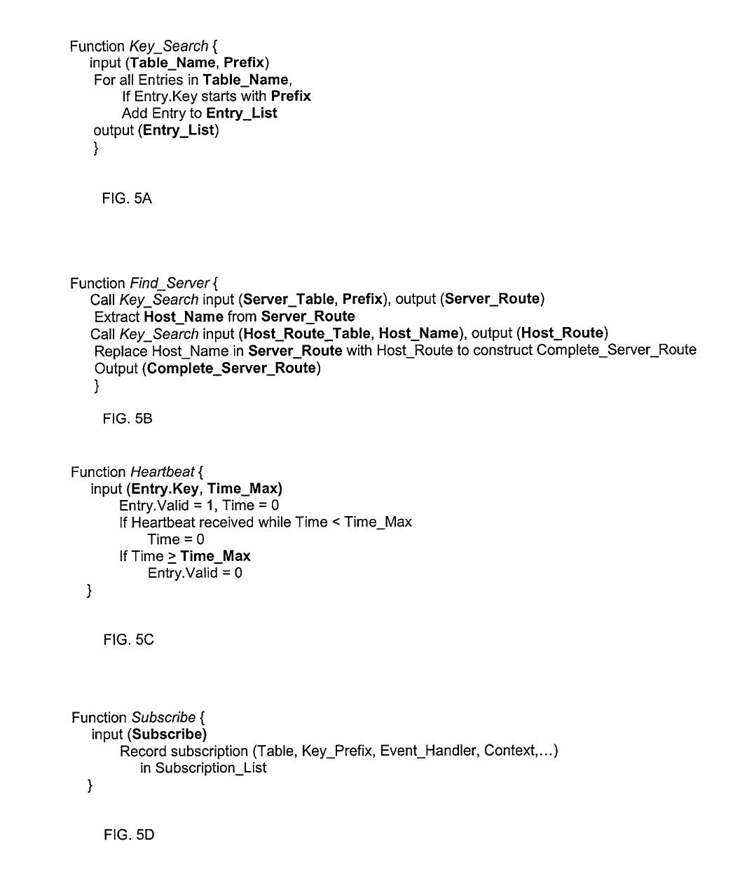

One example of a key search interface function is shown in FIG. 5A, in pseudocode form. A key search interface function can receive the name of a table to be searched (Table_Name), and a key value prefix (Prefix). In one arrangement, a key value prefix can be string. If a null value (“”) is input as a prefix, all values in a table may be returned. Entries that include keys that match a Prefix can be returned as an Entry List.

A find server interface function can search DSD agent tables to retrieve a complete server route for a desired service. A client process uses a complete server route, which is a host route and a server identity on the host, to access a given server process. One example of a find server interface is shown in FIG. 5B. A find server interface can use a first key search entering a particular server table (Server_Table) and key prefix value (Prefix). A Prefix value can determine a particular server process that is desired. The first key search function can then return a list of server routes to appropriate server instances, which can include the name of one or more hosts (Host_Name) having appropriate server instances. A second key search may then be called with a host route table (Host_Route_Table) and host name (Host_Name) as inputs. The second key search can then return a valid network route (Host_Route) to the named host. A complete server route may then be constructed from the server route by replacing the host name component with the valid network route. For example, and without limitation, the complete server route 16.7.13.1:1872 is constructed from the server route HOST9:1872 by replacing HOST9 with the valid network route to HOST9, 16.7.13.1.

Of course, a find server interface function may be used in a different fashion. As noted above, file-identifying information (e.g., a file handle) for a given file can indicate a particular metadata or file partition number. In such a case, a key search function can find a corresponding server instance. Such information can then be used in a find server operation as described, to yield a complete server route to the desired server.

In this way, a client process may invoke a DSD agent find server interface to return a complete server route to access a given server process.

Entry Heartbeat.

A heartbeat interface of a DSD agent can be invoked to maintain current information on a process corresponding to a given table entry. An example of a heartbeat interface function is shown in FIG. 5C. A heartbeat interface function can be called for an entry according to a key value (Entry.Key). At the same time, the valid field for the entry (Entry.Valid) can be set to a valid state (“1”). In addition, the call may further indicate a maximum contact time period (Time_Max). A process corresponding to the entry can then be expected to make periodic communications (heartbeats) to the DSD agent. If a subsequent heartbeat is received from the process before Time_Max is exceeded (Time <Time_Max), a time value can be reset, and the DSD can be conceptualized as waiting for the next heartbeat. If, however, a Time_Max value is reached (Time >Time_Max) and no heartbeat has been received from the process, a particular predetermined action may take place. In the example of FIG. 5C, the predetermined action includes setting the valid field to an invalid state (“0”). Of course any one of various other possible actions could occur, including but not limited to adding and deleting an entry.

In this way, heartbeat interface function may be used to maintain current status information on server processes in a system.

Subscribe/Cancel Subscription.

A subscribe interface can enable a client to respond immediately to changes in DSD tables. A client may include for example and without limitation a client process and directory service master. A cancel subscription interface can cancel a subscription to table updates. One example of a subscribe interface function is shown in FIG. 5D. A subscribe interface function may receive table subscription information (Subscribe) as an input. Subscription information may include:

the name of tables that are subscribed to;

key prefix values that may be used to filter out changes for entries matching such key prefixes;

an identifier for an event handler interface function that is to be invoked by the DSD agent when changes to subscribed table entries occur; and

a context identifier to be returned by the event handler interface function when invoked

The event handler interface function may receive updated table entries, including new or deleted entries, which have been “pushed” from a DSD. If an updated table entry's (Entry.Table) table identifier (for example, DSD_MTID_GATEWAY) matches a subscribed table entry's (Subscribe.Table) table identifier and its key (Entry.Key) starts with the subscribed table entry's key prefix filter (Subscribe.Key_Prefix), the client's event handler is called with the specifics of the update. The updated entry information may be returned to the client process in the function parameters. The specifics of the update may include without limitation events such as “Add” (including modifications), “Delete”, and “Subscribe.” The Subscribe events indicate that some events have been discarded due to resource constraints. As a result, the entire table should be rescanned to detect changes. One example of pushed entry processing is shown in FIG. 5E. In this example, when the Pushed_Entries function gets updated table entries, it compares them with the subscription table (Subscribe.Table). If there is a match, it calls the Subscription.Event_Handler.

Route Updates.

It is noted that while server table heartbeats have been described for maintaining status information on server processes, route information may also be maintained. As but one of the many possible examples, communications over a data network between various processes may occur according to a predetermined protocol. Such a protocol may generate messages when a given route has failed (e.g., a packet is undeliverable). According to such information, host route tables can be updated. Such updated information may then be pushed to DSD agents for caching.

Client Query Operations.

As noted above, according to particular embodiments, a distributed computing system according to the present invention may receive client requests. Such client requests may begin with an access to a DSD agent to determine which server process(es) can service the request. Such an access will be referred to herein as a client query. A DSD agent can process a client query by examining the client request criteria and compare such criteria to information in the various entries in cached relational tables. A route to one or more servers can then be returned to the client. The client may then access the servers and thereby complete a client request.

Client requests may invoke a Key Search and/or Find Server operation as previously described. In the latter case, such an operation may include two table lookups, one to find a server route for a process, the other to determine a route to the host. It is understood that such multiple lookups are opaque to a client. A client may simply query and receive route information.

In one arrangement, clients can subscribe to changes in relevant tables and maintain a list of pending requests to particular server processes. Such pending requests can be compared with changes to server and server route status received by a client as a result of its subscriptions. In this way, if a server and/or route fail while a request is still pending, the request can be cancelled, and a client can query the DSD agent to obtain new route information and resubmit the request using the new route.

As but one example, referring back to FIGS. 2B and 2D, a client may have a pending request to service instance MDS.1 on host machine HOST9. As can be determined from FIG. 2D, such a request may be initially routed to network address 16.7.13.1. Further, service instance MDS.1 includes process MDS.1.1 as a primary service and process MDS.1.0 as a backup process.

Next, it will be assumed that server process MDS.1.1 fails. A local DSD agent can relay such a failure back to a DSD. A DSD may alter the metadata table so that process MDS.1.1 has a valid field with value that indicates the process entry is invalid. Further, process MDS.1.0 may be changed to the primary process. This information may be forwarded to the local DSD agent, which changes its cached metadata tables accordingly.

As a result of its subscription to the metadata table, a DSD agent notifies a client of the changes in the metadata table. A client can redirect its request to the (new) primary process MDS.1.0 on host machine HOST11 by invoking the find server function for service instance MDS.1 In this way, a request may be re-routed to a network address corresponding to host machine HOST11, which can be derived from a host route table.

Of course, in the event of a route failure, a similar process can result in the redirection of request. More particularly, failed route information may be forwarded to a DSD, which can change the status of the failed route, and indicate a backup route as the current route to a host machine. Such information may be forwarded to a local DSD agent. The DSD agent notifies a client of the route failure, and the client can invoke the find server function to obtain an alternate route, for example the backup route.

In this way, pending client requests may be re-directed/re-tried in response to changes in the status of a server process and/or route failure.

Looking now to FIG. 4C, a G/W client 410-2 may have a pending request to service instance MDS.6 408-1. Next, route to MDS.6 fails, and an event is generated. Route failures can be caused by for example, server crash, network card failure, switch and network fabric failure, Local DSD agent 402-2 detects the event. DSD agent 402-2 then sends a failure notification to the DSD 402-1, which sends the failure notification to all DSDAs 402-0, 4025, and 402-6 on the communication network 406 via private protocol messages. All DSDAs, 402-0, 402-5, and 402-6 receive the failure notification. The client process G/W 410-2 gets the failure notification via its subscription to such events. The client process G/W 410-2 then retries the request by redirecting the request to an alternate route. This retry feature with DSD notification eliminates long protocol timeouts that can occur if a server is not responding.

Server Management.

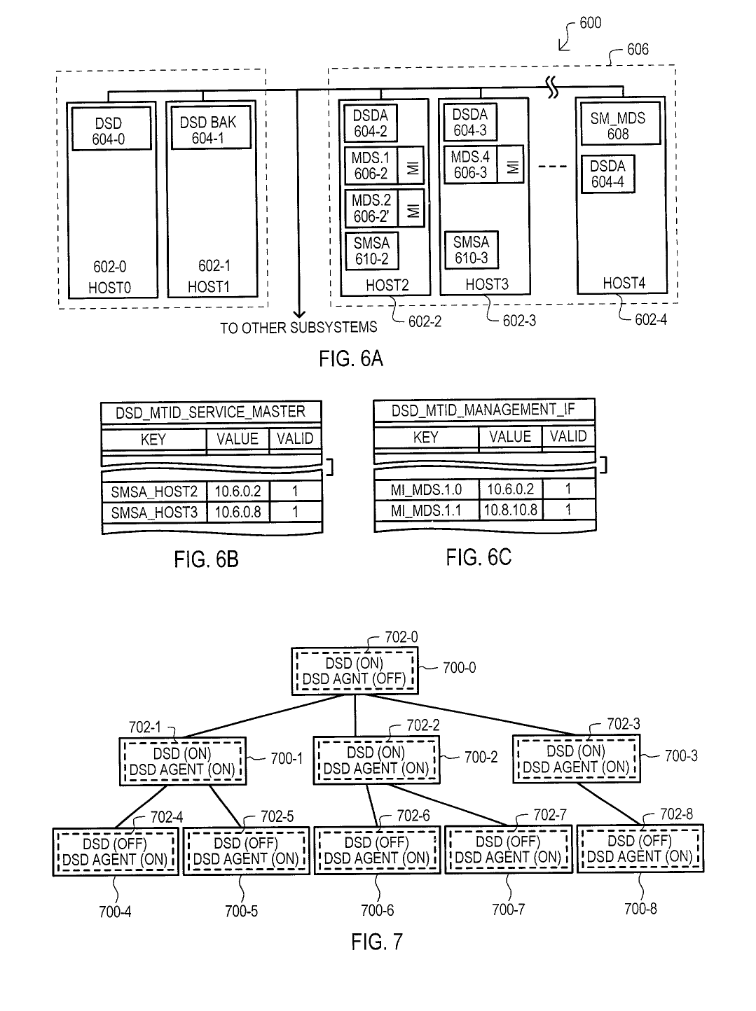

While a DSD may include information for selecting particular server processes, a DSD may also include information for servicing and otherwise maintaining server processes. One example is shown in FIGS. 6A to 6C. FIG. 6A shows a portion of a distributed computing system that is designated by the general reference character 600. The system 600 includes host machines 602-0 and 602-1 in which may reside a primary DSD 604-0 and a back-up DSD 604-1. One of multiple subsystems 606 is shown to include host machines 602-2 to 602-4. Host machines 602-2 and 602-3 include DSD agents 604-2 and 604-3, and server processes 606-2, 606-2′ and 606-3.

According to one embodiment, a service master (SM) can manage each service. The SM of FIG. 6 is shown as 608, and resides on host machine 602-4 which includes DSD Agent 604-4. A SM may operate in conjunction with system management service agents (SMSA) (610-2 and 610-3) that reside on the other host machines of the subsystem. SMSAs (610-2 and 610-3) can be represented by entries in a system management service agent relational table, an example of which is shown in FIG. 6B. A system management service agent relational table may have the same general format as those tables shown in FIGS. 2A to 2F. Namely, a key field can identify a particular SMSA, a value field can identify a route to the host machine for the SMSA, and a valid field can indicate the status of the SMSA. A SM can subscribe to a service management service agent table for its particular service. This can allow a SM to contact and invoke functions in SMSAs.

In operation, a SM may search a table for a desired SMSA, and then contact the SMSA to perform a particular operation. Such operations may include, but are not limited to, starting a server process, running a command, killing a server process, shutting down the host, and shutting down and then restarting the host (rebooting). Starting a server process may include providing particular variables for example and without limitation command line parameters and environment variables to the server process to specify the functionality of process. Such an operation may return a process identification value assigned by the host operating system.

An SM can monitor the various server processes of its corresponding subsystem by subscribing to relational tables containing status information. As but one example, if reference made back to FIG. 2B, and SM for a metadata subsystem can monitor valid field values for the corresponding server processes of the metadata subsystem. If a valid field changes to contain an invalid indication, a SM may undertake a variety of actions, including but not limited to entering a work order for the server, or contacting various SMSAs. For example, a SM can contact an SMSA for the host of the failed server process. The SMSA may then attempt to restart the server or reboot the host. Still further, a SM could contact a SMSA on a different host to start a replacement server process on the different host. Of course any one of various other possible actions could occur, including but not limited to attempting to restart a process, deleting the entry, executing various administrative steps (e.g., generating work orders, notifying a system administrator) and/or activating a backup server process.

An SM may also control the various server processes of its subsystem. For example, as shown in FIG. 6A, each server process can have a corresponding management interface. (MI). An MI may perform various functions invoked by an SM. As but a few of the possible examples, a MI may get various attributes of a server process, set the attributes for a process, or invoke selected functions of a process. A get attribute function may fetch statistical information for a given process (e.g., current resource usage). A set attributes function can determine the functionality of a server process, including tuning a process for particular environments.

MIs, like SMSAs may also be registered in a relational table within a DSD. One example of such a table is shown in FIG. 6C. Such a table may be cached in a SM, and subscribed to.

In this way, server processes may be started, terminated, monitored and tuned by a Service Master through the use of SMSAs and MIs. Service Masters may further provide load balancing of a subsystem by starting and stopping server processes according to system loads. A master service process may then control multiple service masters.

It is also understood, that while a service master for the processes of a subsystem have been described, a service master may be included for the other subsystems as well. Still further, a service master may also operate on system hardware. System hardware can be monitored, and in the event of a failure, an alternate piece of hardware may be enabled and/or otherwise configured for use. A few of many possible types of hardware/components that may be controlled by a service master include network interfaces, network firewalls, network switches, directors and power controllers.

DSD Redundancy.

To help ensure DSD redundancy, as shown in FIG. 1, DSDs may run on multiple resources. Thus, as one resource fails, another back-up resource may provide DSD functions.

In one particular arrangement, when a DSD is first initialized, it may broadcast its presence on the communication network, which joins the various host machines. Any other DSDs may then negotiate with the broadcasting DSD to establish which DSD is a master and which is a backup.

DSD Scalability.

As a system grows, a DSD may also have to grow to prevent a DSD from becoming a bottleneck in a system. On example of DSD scalability is shown in FIG. 7. In one particular arrangement, a process may include both DSD and DSD agent functions. Which particular functions are enabled can determine if a process functions as a DSD, a DSD agent, or both.

Referring now to FIG. 7, one example of multiple DSD/DSD agent processes are shown on nine different host machines 700-0 to 700-8. Host 700-0 can illustrate a first DSD layer. In such a layer, DSD functions may be turned on, while DSD agent functions can be turned off. Thus, a process 702-0 may function as a first level DSD.

Host machines 700-1 to 700-3 can illustrate a second layer. In such a layer, DSD and DSD agent functions may both be turned on. Thus, processes 702-1 to 702-3 may function as DSD agents for process 702-0, but function as DSDs to third level processes described below.

Resources 700-4 to 700-8 can illustrate a third layer. In such a layer, DSD functions may be turned off, and DSD agent functions may be turned on. Thus, processes 702-4 to 702-8 may function as DSD agents. However, unlike a single DSD case, DSD agents 702-4 and 702-5 may cache values from second layer DSD 702-1, DSD agents 702-6 and 702-7 may cache values from second layer DSD 702-2, while DSD agents 702-3 may cache values from second layer DSD 702-3. This can prevent first level DSD 702-0 from becoming a bottleneck by having to supply table information to a large numbers of DSD agents.

In this way, a hierarchy of DSDs may be provided to reduce the load on a single DSD and thereby enabling a DSD to scale up as needed.

Of course, the various described embodiments and examples represent but particular embodiments of the present invention. It is thus understood that while the preferred embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A dynamic server directory system, comprising:
at least one relational table that includes a plurality of entries that can each store location data, status data, and feature data of server processes in a distributed computing system that services client requests; and
an interface that may provide at least one entry from the at least one relational table to a client.

2. The dynamic server directory system of claim 1, wherein:
the location data of an entry may comprise a network address; and
the entry may include a server name to identify a specific server at the network address.

3. The dynamic server directory system of claim 1, further including:
a route table that can indicate at least one communication route to a server host and the status of said route.

4. The dynamic server directory system of claim 1, further including:
a plurality of dynamic server directory agents that reside on different host machines than the dynamic server directory, each dynamic server directory agent caching at least a portion of the at least one relational table.

5. The dynamic server directory system of claim 1, wherein:
the relational table includes a key field that may be searched by a key prefix value that can filter entries according to client request criteria

6. The dynamic server directory system of claim 1, further including:
a plurality of dynamic server directory agents that reside on different host machines than the dynamic server directory, each dynamic server directory agent forwarding new server process information to the dynamic server directory when a new server process is added; and
the dynamic server directory creating a new entry in the at least one relational table corresponding to the server process and forwarding the updated relational table to dynamic server directory agents.

7. The dynamic server directory system of claim 1, wherein:
the distributed computing system includes at least two subsystems that provide different functions; and
the at least one relational table includes a plurality of relational tables, each relational table including entries corresponding to server processes of one of the subsystems.

8. The dynamic server directory system of claim 1, wherein:
the at least one relational table includes a server relational table that identifies a server route corresponding to a given server process and a route relational table that identifies a communication route corresponding to a given host machine.

9. The dynamic server directory system of claim 8, further including:
the interface searches the server relational table and then the route relational table to determine the route to a host machine for a given server process.

10. The dynamic server directory system of claim 1, further including:
a plurality of dynamic server directory agents that reside on different host machines than the dynamic server directory, each dynamic server directory agent receiving periodic status communications from at least one server process and notifying the dynamic server directory when status communications fail; and
the dynamic server directory changes entries in the at least one relational table in response to status communication failures.

11. The dynamic server directory of claim 10, further including:
a service master process that may subscribe with the DSD agent to be notified of changes to the at least one relational table, the service master performing at least one predetermined error response when the change to the at least one relational table indicates a status communication failure has occurred in a server process; and
the dynamic server directory forwards changes in the at least one relational table to the DSD agent.

12. The dynamic server directory of claim 11, wherein:
the predetermined error response may be at least one response selected from the group consisting of: attempting to restart the server process corresponding to the failure, logging the failure error, notifying a system administrator, generating a work order for the server process corresponding to the error, activating another server process as a back-up to the server process corresponding to the failure, shutting down a host machine for the server process corresponding to the failure, and rebooting a host machine for the server process corresponding to the failure.

13. The dynamic server directory of claim 1, wherein:
a plurality of client processes that may subscribe to be notified of changes to the at least one relational table, a client process performing a resubmission of all requests sent on a particular currently valid server route when the change to the at least one relational table indicates a failure in the server process, or the route to the server process.

14. A system, comprising:
a plurality of servers that may perform predetermined operations according to requests from clients; and
a dynamic server directory that includes a plurality of relational tables, each relational table storing feature information for the plurality of servers, the feature information being accessible by a client to determine which server may service a particular client request; and
a plurality of dynamic server directory agents that may perform predetermined operations according to client subscriptions.

15. The system of claim 14, wherein:
the plurality of servers include storage servers that may access stored files and metadata servers that may access metadata for the stored files.

16. The system of claim 14, wherein:
the dynamic server directory agent includes an inter face that may provide access to the relational tables in response to an action selected from the group consisting of: the addition of a new entry to a relational table, deletion of a entry from a relational table, search for a key, search for a server, subscription to notification of changes in status, and maintenance of current process information.

17. The system of claim 14, further including:
the plurality of servers reside on server host machines; and
each server host machine further includes a dynamic server directory agent that caches at least a portion of at least one relational table and is accessible by a client.

18. A method of controlling client requests in a distributed computing system having a plurality of servers, comprising the steps of:
maintaining server information in a dynamic server directory (DSD) for the servers that indicates availability of a server for particular client requests;
caching server information in dynamic server directory agents (DSDAs);
selecting a server for a particular client request from server information cached in a DSD;
monitoring servers with DSDAs and forwarding server status information to the DSD;
changing server information in the DSD for a selected server in response to server status information; and
forwarding changed server information to DSDAs.

19. The method of claim 18, wherein:
selecting a server includes a client invoking an interface function of a DSDA residing on the same host machine as the client.

20. The method of claim 18, wherein:
selecting a server includes searching a first server information relational table to determine a server route including a host machine on which a desired server resides, and searching a second server information relational table to determine a route to the host machine.

21. The method of claim 18, wherein:
the server information includes
at least one server relational table having entries that comprise server identification, server route identification including host machine identification, and a server status indication for each server process, and
at least one route relational table having entries that comprise host machine identification, route information, and host machine status indication.

22. The method of claim 21, further including:
the plurality of servers includes a gateway servers that control access to the distributed computing system, metadata servers that access metadata for stored files, and storage servers that store files; and
the at least one server relational table includes a gateway server relational table, a metadata server relational table, and a storage server relational table.
